(19) United States
(12) Patent Application Publication
(10) Pub. No.: US 2010/0292416 A1
(43) Pub. Date: Nov. 18, 2010

(54) METHODS AND APPARATUS FOR POLYMERIZATION

(75) Inventors: Marc L. DE CHELLIS, Houston, TX (US); Mark B. DAVIS, Lake Jackson, TX (US); Brian R. BERG, Humble, TX (US)

Correspondence Address: UNIVATION TECHNOLOGIES, LLC, 5555 SAN FELIPE, SUITE 1950, HOUSTON, TX, 77056, US

(73) Assignee: UNIVATION TECHNOLOGIES, LLC, Houston, TX (US)

(21) Appl. No.: 12/780,143

(22) Filed: May 14, 2010

Related U.S. Application Data
(60) Provisional application No. 61/178,670, filed on May 15, 2009.

(51) Int. Cl. C08F 2/01; B01J 8/08

(52) U.S. Cl. 526/69; 422/131

(57) ABSTRACT

Apparatus and methods for olefin polymerization are provided. A fluidized bed reactor may include a cylindrical section, a dome, a transition section between the cylindrical section and the dome, at least three outlet nozzles disposed on the dome, and a recycle line in fluid communication with the at least three outlet nozzles.

### CROSS REFERENCE TO RELATED APPLICATIONS

This application claims the benefit of Ser. No. 61/178,670, filed May 15, 2009, the disclosure of which is incorporated by reference in its entirety.

### FIELD OF THE INVENTION

Embodiments of the present invention generally relate to apparatus and methods for olefin polymerization.

### BACKGROUND

In gas-phase polymerization, a gaseous stream containing one or more monomers is passed through a fluidized bed under reactive conditions in the presence of a catalyst. A polymer product is withdrawn from the reactor while fresh monomer is introduced to the reactor to replace the removed polymerized product. Unreacted monomer and catalyst is withdrawn from the fluidized bed and recycled back to the reactor.

Process upsets in the reactor are often related to the buildup of catalyst and polymer in the top of the reactor where the outlet nozzles to the recycle loop is located. This buildup can occur, for example, due to insufficient mixing and/or insufficient sweeping of the gas along the walls where catalyst can continue to react and fuse with polymer fines. As a result, large agglomerations known as “dome sheets” accumulate or form on the reactor walls near the top of the reactor. When these dome sheets fall into the fluidized bed, fluidization can be disrupted, which can require the reactor to be shut down.

There is a need, therefore, for improved systems and methods for reducing or eliminating the formation of dome sheets within a fluidized bed reactor.

### SUMMARY

Apparatus and methods for olefin polymerization are provided. In at least one specific embodiment, a fluidized bed reactor can include a cylindrical section, a dome, a transition section between the cylindrical section and the dome, at least three outlet nozzles disposed on the dome, and a recycle line in fluid communication with the at least three outlet nozzles.

In at least one specific embodiment, a method for olefin polymerization can include forming a fluidized bed within a fluidized bed reactor. The fluidized bed can include a plurality of solid particles. The fluidized bed reactor can include a cylindrical section, a dome, a transition section between the cylindrical section and the dome, at least three outlet nozzles disposed on the dome, and a recycle line in fluid communication with the at least three outlet nozzles. The method can also include removing a recycle stream from the fluidized bed reactor through the at least three outlet nozzles.

### BRIEF DESCRIPTION OF THE DRAWINGS

FIG. 1 depicts a partial elevational view of an illustrative reactor having three outlet nozzles, according to one or more embodiments described.

FIG. 2 depicts a top view of the dome depicted in FIG. 1.

FIG. 3 depicts another illustrative top view of the dome having four outlet nozzles disposed thereabout, according to one or more embodiments described.

FIG. 4 depicts yet another illustrative top view of the dome having five outlet nozzles disposed thereabout, according to one or more embodiments described.

FIG. 5 depicts the simulated velocity contour of a horizontal cross-section of a top head of the reactor depicted in FIG. 1 having a single outlet nozzle centrally disposed on the dome, according to one or more embodiments described.

FIG. 6 depicts the simulated velocity contour of a vertical cross-section of the top head shown in FIG. 5.

FIG. 7 depicts the simulated velocity contour of a horizontal cross-section of a top head of the reactor depicted in FIG. 1 having four outlet nozzles disposed on the dome, according to one or more embodiments described.

FIG. 8 depicts the simulated velocity contour of a vertical cross-section of the top head shown in FIG. 7.

FIG. 9 depicts the simulated velocity contour of a horizontal cross-section of the top head of the reactor depicted in FIG. 1.

FIG. 10 depicts the simulated velocity contour of a vertical cross-section of the top head shown in FIG. 9 with the cross-section being shown perpendicular to the three linearly disposed outlet nozzles.

FIG. 11 depicts the simulated velocity contour of a vertical cross-section of the top head shown in FIGS. 8 and 9 with the cross-section being shown along the plane of the three linearly disposed outlet nozzles.

FIG. 12 shows the simulated wall shear stresses of the vertical cross-sections shown in FIGS. 6, 8, 10, and 11.

FIG. 13 depicts a flow diagram of an illustrative gas phase system for making polyolefins, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

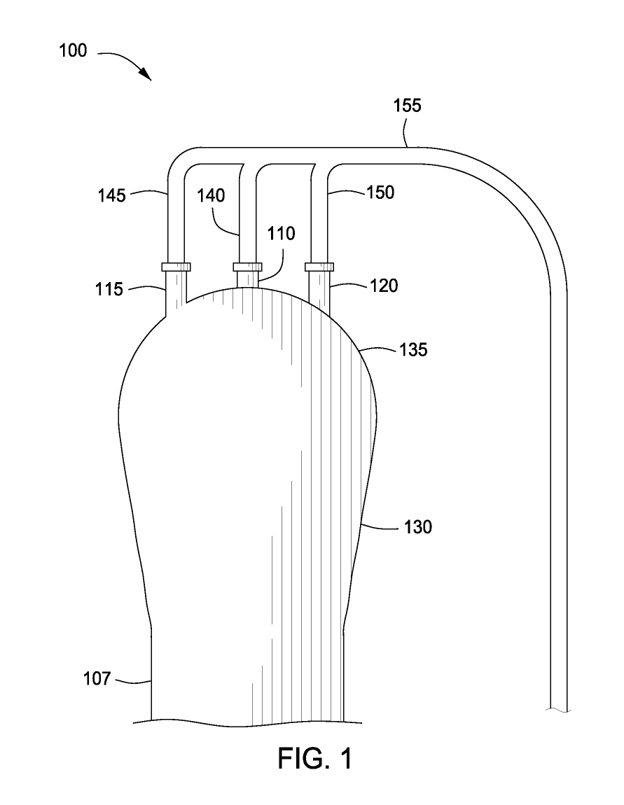

FIG. 1 depicts a partial elevational view of an illustrative reactor 100 having three outlet nozzles 110, 115, 120, according to one or more embodiments. The reactor 100 can include a cylindrical section 107, a transition section 130, and a dome or top head 135. The cylindrical section 107 is disposed adjacent the transition section 130. The transition section 130 can expand from a first diameter that corresponds to the diameter of the cylindrical section 107 to a larger diameter adjacent the dome 135. The dome 135 has a bulbous shape. The outlet nozzles 110, 115, 120 are in fluid communication with a recycle line 155. The outlet nozzles 110, 115, 120 can be tied into the recycle line 155 via lines 140, 145, and 150. Each line 140, 145, and 150 can be independently controlled to regulate flow therethrough. As such, each outlet nozzle 110, 115, 120 can be independently controlled, opened, and/or closed with relation to the recycle line 155.

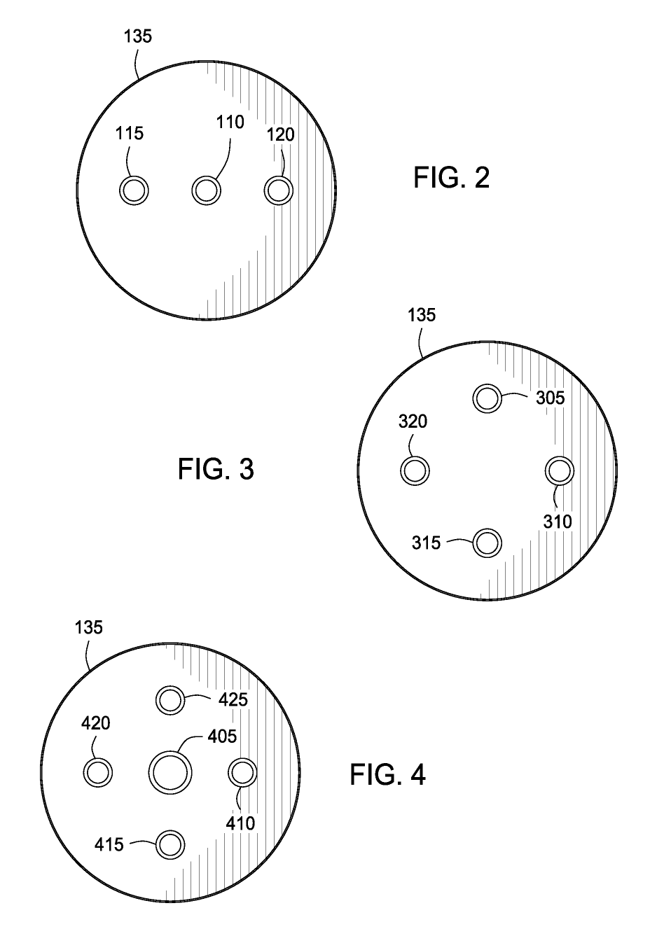

FIG. 2 depicts a top view of the dome 135 depicted in FIG. 1. The first outlet nozzle 110 can be centrally disposed on the dome 135 with the second and third outlet nozzles 115, 120 disposed on either side. The outlet nozzles 110, 115, 120 can be linearly disposed across the dome 135 or randomly located about the dome 135. In a preferred embodiment, the outlet nozzles 110, 115, 120 are linearly disposed along a central line of the dome 135.

The outlet nozzles 110, 115, 120 can have any suitable cross-sectional shape. For example, the cross-sectional shape of the outlet nozzles 110, 115, 120 can be circular, elliptical, oval, triangular, square, rectangular, or any other desirable cross-sectional shape. In one or more embodiments, the cross-sectional shape of the outlet nozzles 110, 115, 120 can be the same or different with respect to one another. For example, the cross-sectional shape of the first outlet nozzle 110 can be circular and the cross sectional shape of the second and third outlet nozzles 115, 120 can be elliptical. In a preferred embodiment, the cross-sectional shape of the outlet nozzles 110, 115, 120 is circular.

The size of each outlet nozzle 110, 115, 120 can be the same or different. For example, each outlet nozzle 110, 115, 120 can have a diameter ranging from a low of about 0.3 m, about 0.46 m, or about 0.61 m to a high of about 1.07 m, about 1.22 m, about 1.37 m, about 1.52 m, or about 1.68 m. The cross-sectional area of each outlet nozzle 110, 115, 120 can range from a low of about 0.07 m², about 0.17 m², about 0.3 m² to a high of about 0.9 m², about 1.2 m², about 1.5 m², about 1.8 m², or about 2.2 m². The cross-sectional shape and size of the outlet nozzles 110, 115, 120 can be based at least in part on various factors, which can include but are not limited to, the size of reactor 100, level or amount of desired production of one or more products, flow rates, material availability, and cost. In at least one specific embodiment, the first outlet nozzle 110 can have a diameter of about 1.07 m and the second and third nozzles 115, 120 can have a diameter of about 0.61 m. In at least one other specific embodiment, the first, second, and third outlet nozzles 110, 115, 120 can each have a diameter of about 0.61 m.

FIG. 3 depicts another illustrative top view of the dome 135 having four outlet nozzles (305, 310, 315, 320) disposed thereabout, according to one or more embodiments. The outlet nozzles 305, 310, 315, 320 can have any suitable cross-sectional shape. For example, the cross-sectional shape of the outlet nozzles 305, 310, 315, 320 can be circular, elliptical, oval, triangular, square, rectangular, or any other desirable cross-sectional shape. In one or more embodiments, the cross-sectional shape of the outlet nozzles 305, 310, 315, 320 can be the same or different with respect to one another. For example, the cross-sectional shape of the first outlet nozzle 305 can be circular and the cross sectional shape of the second, third, and fourth outlet nozzles 310, 315, 320 can be elliptical. In a preferred embodiment, the cross-sectional shape of the outlet nozzles 305, 310, 315, 320 is circular.

The size of each outlet nozzle 305, 310, 315, 320 can be the same or different. For example, each outlet nozzle 305, 310, 315, 320 can have a diameter ranging from a low of about 0.3 m, about 0.46 m, or about 0.61 m to a high of about 1.07 m, about 1.22 m, about 1.37 m, about 1.52 m, or about 1.68 m. The cross-sectional area of each outlet nozzle 305, 310, 315, 320 can range from a low of about 0.07 m², about 0.17 m², about 0.3 m² to a high of about 0.9 m², about 1.2 m², about 1.5 m², about 1.8 m², or about 2.2 m². The cross-sectional shape and size of the outlet nozzles 305, 310, 315, 320 can be based at least in part on various factors, which can include but are not limited to, the size of reactor 100, level or amount of desired production of one or more products, flow rates, material availability, and cost.

The outlet nozzles 305, 310, 315, 320 can be disposed on the dome 135 in any desired configuration. The outlet nozzles 305, 310, 315, 320 can be disposed about the center of the dome 135, such that each outlet nozzle is positioned at a corner of a “square” formed by the nozzles 305, 310, 315, 320. The outlet nozzles 305, 310, 315, 320 can be disposed about the center of the dome 135, such that each outlet nozzle is positioned at a corner of a “rectangle” formed by the nozzles 305, 310, 315, 320. The first outlet nozzle 305 can be centrally disposed on the top of the dome 135 and the second, third, and fourth outlet nozzles 310, 315, 320 can be disposed equidistant from the first nozzle 305, in a “triangle” arrangement about the first outlet nozzle 305. The outlet nozzles 305, 310, 315, 320 can be disposed about the dome 135 such that one nozzle is disposed in each quadrant of the dome 135. In a preferred embodiment, the outlet nozzles are arranged equidistant from the center of the dome 135 and each other, in a “square” arrangement.

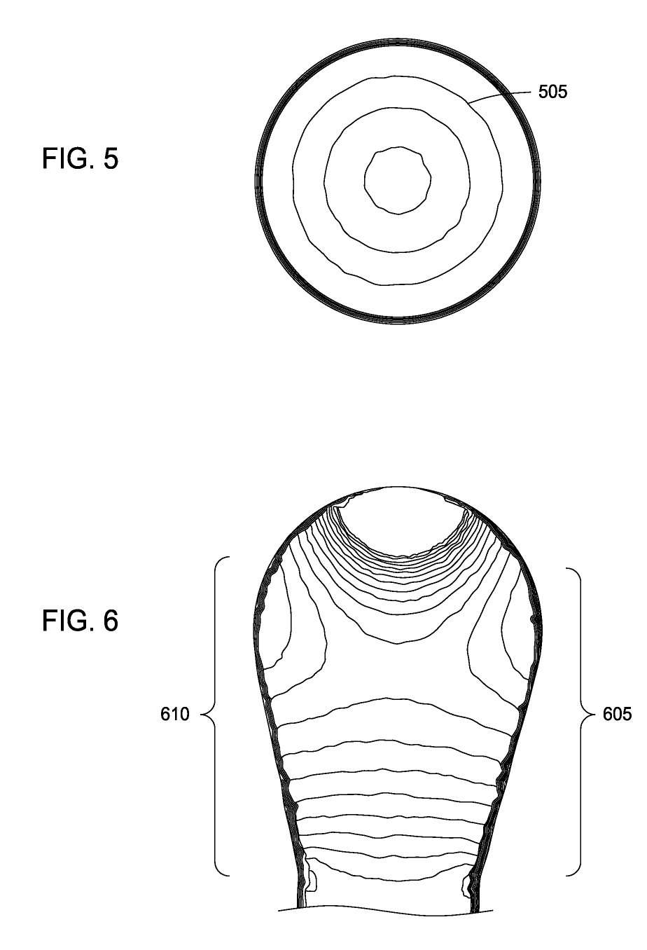

FIG. 4 depicts yet another illustrative top view of the dome 135 having five outlet nozzles (405, 410, 415, 420, 425) disposed thereabout, according to one or more embodiments. The outlet nozzles 405, 410, 415, 420, 425 can have any suitable cross-sectional shape. For example, the cross-sectional shape of the outlet nozzles 405, 410, 415, 420, 425 can be circular, elliptical, oval, triangular, square, rectangular, or any other desirable cross-sectional shape. In one or more embodiments, the cross-sectional shape of the outlet nozzles 405, 410, 415, 420, 425 can be the same or different with respect to one another. In a preferred embodiment, the cross-sectional shape of the outlet nozzles 405, 410, 415, 420, 425 is circular.

The size of each outlet nozzle 405, 410, 415, 420, 425 can be the same or different. For example, each outlet nozzle 405, 410, 415, 420, 425 can have a diameter ranging from a low of about 0.3 m, about 0.46 m, or about 0.61 m to a high of about 1.07 m, about 1.22 m, about 1.37 m, about 1.52 m, or about 1.68 m. The cross-sectional area of each outlet nozzle 405, 410, 415, 420, 425 can range from a low of about 0.07 m², about 0.17 m², about 0.3 m² to a high of about 0.9 m², about 1.2 m², about 1.5 m², about 1.8 m², or about 2.2 m². The cross-sectional shape and size of the outlet nozzles 405, 410, 415, 420, 425 can be based at least in part on various factors, which can include but are not limited to, the size of reactor 100, level or amount of desired production of one or more products, flow rates, material availability, and cost.

The outlet nozzles 405, 410, 415, 420, 425 can be disposed on the dome 135 in any desired configuration. For example, four outlet nozzles 410, 415, 420, 425 can be disposed about a centrally located or centrally disposed nozzle 405, such that each nozzle 410, 415, 420, 425 is positioned at a corner of a “square” formed by those nozzles. Outlet nozzles 410, 415, 420, 425 can be disposed about the centrally disposed nozzle 405, such that each outlet nozzle 410, 415, 420, 425 is positioned at a corner of a “rectangle” formed by the nozzles 410, 415, 420, 425. The outlet nozzles 410, 415, 420, 425 can be disposed about the centrally disposed nozzle 405, such that one outlet nozzle is disposed in each quadrant of the dome 135, with the centrally disposed outlet nozzle 405 positioned at the intersection of each quadrant of the dome. In another embodiment, the five nozzles 405, 410, 415, 420, 425 can be arranged equidistant from the center of the dome 135 and each other in a “circular” configuration.

Although not shown, any number of outlet nozzles having the same or varying cross-sectional areas can be disposed on the dome 135. In one or more embodiments, two outlet nozzles, three outlet nozzles, four outlet nozzles, five outlet nozzles, six outlet nozzles, seven outlet nozzles, eight outlet nozzles, nine outlet nozzles, ten outlet nozzles, eleven outlet nozzles, twelve outlet nozzles, thirteen outlet nozzles, fourteen outlet nozzles, or fifteen outlet nozzles can be disposed about the dome 135.

Although not shown, any one or more of the outlet nozzles 110, 115, 120, 305, 310, 315, 320, 405, 410, 415, 420, and/or 425 discussed and described above with reference to FIGS. 1-4 can be tapered. Tapered outlet nozzles can be any shape and can be constructed of any materials suitable for the fluidization process of interest. In at least one specific embodiment, the tapered outlet nozzle can include a transition section in the shape of a conical frustum. In at least one other specific embodiment, the tapered outlet can include a transition section with a parabolic cone shape. In one or more embodiments, the tapered nozzle can include a first outlet cross-section at a first end and a second outlet cross-section at a second end, such that the first outlet cross-section is greater than the second outlet cross-section. In one or more embodiments the second outlet cross-section can be substantially equal to the cross-section of the lines 140, 145, 150 that can be tied to the recycle line 155. In one embodiment, the first outlet cross-section is at least about 1.2 times the second outlet cross section, preferably the first outlet cross section is at least about 2.0 times the second outlet cross section, and even more preferably the first outlet cross section is at least about 3.0 times the second outlet cross section. The cross sections referenced in this application are the inside cross sections, e.g., the diameter, of the subject parts, unless otherwise noted.

In one or more embodiments, the dome 135 of an existing reactor 100 can be retrofitted to include more than one outlet nozzle, for example, three outlet nozzles 110, 115, 120 disposed thereabout. For example, an existing reactor 100 having only one outlet nozzle 110 centrally disposed on the dome 135 can be retrofitted to include a second and third outlet nozzle 115, 120 disposed on either side of the single outlet nozzle 110. Reducing or reduction flanges can be used to connect the existing outlet nozzle 110 to the recycle line 155, should it be desirable to reduce the cross-section of the existing outlet nozzle 110.

FIGS. 5-12 are derived from Computational Fluid Dynamics (“CFD”) simulations. CFD simulations are widely used to simulate gas flow fields, and was used to model the flow field in the top section of a gas-phase polyethylene reactor having different outlet nozzle configurations. A summary of the CFD results is shown in FIGS. 5-12 and Table 1 below.

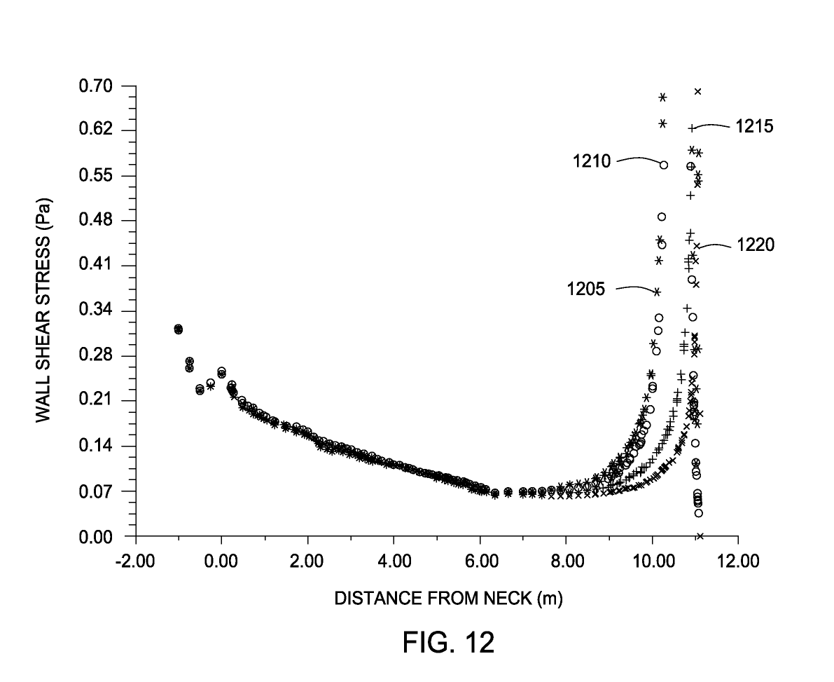

To generate the results depicted in FIGS. 5-12 and Table 1, the superficial gas velocity (“SGV”) was set at 0.79 m/s, the gas density was 30.9 kg/m³, and the gas viscosity was 1.35×10⁻⁵ Pa-s. An arbitrary gas velocity of 0.3 m/s was chosen in order to compare the simulated effects of the different outlet nozzle configurations using the same reactor dimensions. The “neck” refers to the junction of the cylindrical section 107 and the transition section 130 of the reactor 100. Reducing the distance between the 0.3 m/s velocity contour line and the wall of the reactor reduces the probability of any particulates (i.e., polymer and/or catalyst particles) from depositing onto the wall of the reactor. In other words, increasing the velocity along the inside wall of the reactor 100 reduces the probability of any particulates (i.e., polymer and/or catalyst particles) from depositing onto the wall of the reactor. This is demonstrated by showing the changes in velocity flow contours in FIGS. 5, 7, 9, as well as the change in wall shear stress, shown in FIG. 12. Reducing the distance or height of the 0.3 m/s velocity contour line from the neck of the reactor provides a greater degree of sweeping action on the wall of the transition section 130 and dome 135 (see FIG. 1). The velocity profile from the top of the cylindrical section 107 through the transition section 130 steadily and somewhat uniformly decreases and reaches a lowest velocity at the transition between the transition section 130 and the dome 135. The velocity profile begins to somewhat uniformly increase again at this point. The extent to which the velocity profile increases within the dome 135 can be quantified by the location of the 0.3 m/s velocity contour in relation to a fixed point, in this case the “neck” of the reactor vessel. This particular velocity contour (0.3 m/s) was chosen for convenience. Any of the velocity contours could be used to quantify the differences in velocity profiles between different outlet configurations. The cross-sections shown in FIGS. 5, 7, and 9 were taken at the transition point of the reactor 100 between the transition section 130 and the dome 135 (see FIG. 1).

TABLE 1
Summary of Simulated Effects of Different Reactor Nozzle
Configurations

| | | Distance of | | |
|---|---|---|---|---|
| | | the 0.3 m/s | Distance of | Distance of |
| | | Velocity | the 0.3 m/s | the 1 m/s |
| Reactor | | Contour | Velocity | Velocity |
| Nozzle | Location About | from the | Contour | Contour |
| Config- | the Nozzle | Wall of | from the | from the |
| uration | Configuration | Reactor 100 | Neck | Neck |
| Single | N/A | 1.2 m, Ref. | 8.7 m; Ref. | 9.2 m; Ref. |
| Nozzle | | No. 505 | No. 605 | No. 610 |
| Four Nozzles | N/A | 1.1 m; Ref. | 8.4 m; Ref. | 9.6 m; Ref. |
| | | No. 705 | No. 805 | No. 810 |
| Three | At an end of | 0.4 m; Ref. | 7.9 m; Ref. | 9.4 m; Ref. |
| Linearly | the aligned | No. 910 | No. 1105 | No. 1110 |
| Aligned | nozzles | | | |
| Nozzles | | | | |
| Three | Perpendicular | 1.4 m; Ref. | 9.2 m; Ref. | 9.9 m; Ref. |
| Linearly | to the plane of | No. 905 | No. 1005 | No. 1010 |
| Aligned | the aligned | | | |
| Nozzles | nozzles | | | |

FIG. 5 shows a velocity of 0.3 m/s indicated at reference number 505 that is 1.2 m from the inner wall of the reactor 100. The bracket 605, shown in FIG. 6, indicates the top of the 0.3 m/s velocity contour extends 8.7 m from the neck (bottom) of the transition section 130. These figures represent the standard single outlet design and are used as a reference point to illustrate the improvements gained by using multiple outlet nozzle configurations discussed and described herein.

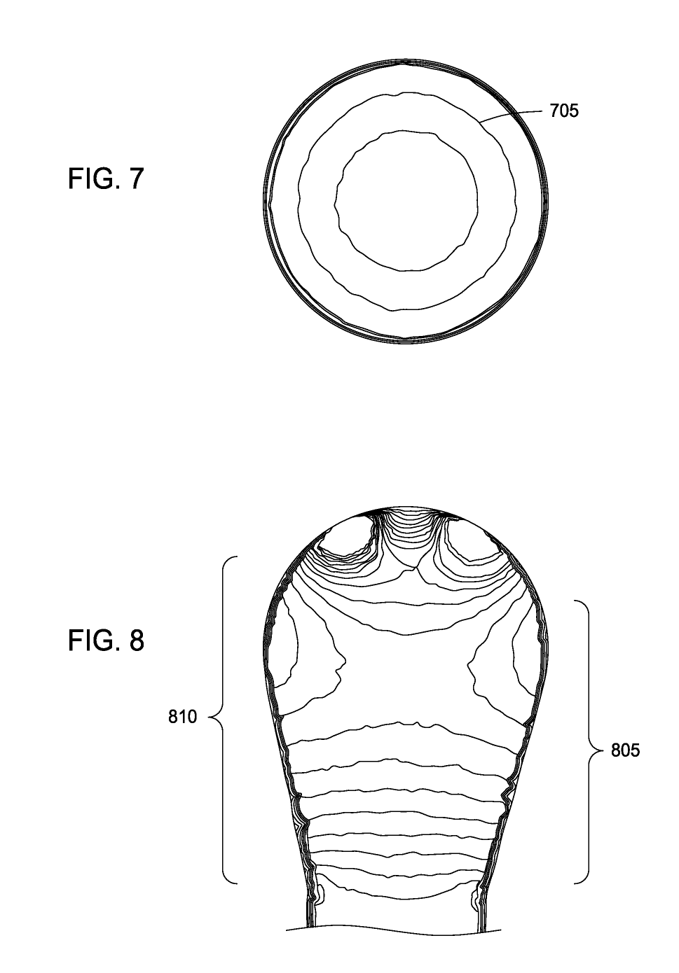

FIG. 7 shows a velocity of 0.3 m/s, indicated at reference number 705 that is 1.1 m from the inner wall of the reactor 100. The bracket 805, shown in FIG. 8, indicates the top of the 0.3 m/s velocity contour extends 8.4 m from the neck (bottom) of the transition section 130. is indicated by bracket 710. The location of the velocity contour associated with reference number 705, as compared with the same contour associated with reference number 505 in FIG. 5, indicates that the velocity profile is more evenly distributed in the direction perpendicular to flow and is less likely to carry particles (i.e., polymer and/or catalyst particles) into the recycle line 155 (see FIG. 1). The reduction in distance, shown by bracket 805, when compared to bracket 605 in FIG. 6, indicates improved wall sweeping in the dome 135 as the velocity profile increases faster than in the single outlet case.

FIG. 9 depicts the simulated velocity contour of a horizontal cross-section of a dome 135 of a reactor 100 having three 0.61 m diameter nozzles linearly disposed on the top of the dome 135, as discussed and described above with reference to FIGS. 1 and 2. The three nozzle configuration shows an oblong velocity contour flow pattern. The three nozzle configuration shows a velocity of 0.3 m/s, indicated at reference number 905, that is 1.4 m from the inner wall of the reactor 100. However, the three nozzle configuration also shows a velocity of 0.3 m/s, indicated at reference number 910 that is only 0.4 m from the inner wall of the reactor 100. The location of the velocity contour associated with reference numbers 905 and 910, as compared with the same contour associated with reference number 505 in FIG. 5 indicates that the velocity profile is more evenly distributed in the direction perpendicular to flow and is less likely to carry particles (i.e., polymer and/or catalyst particles) into the recycle line 155.

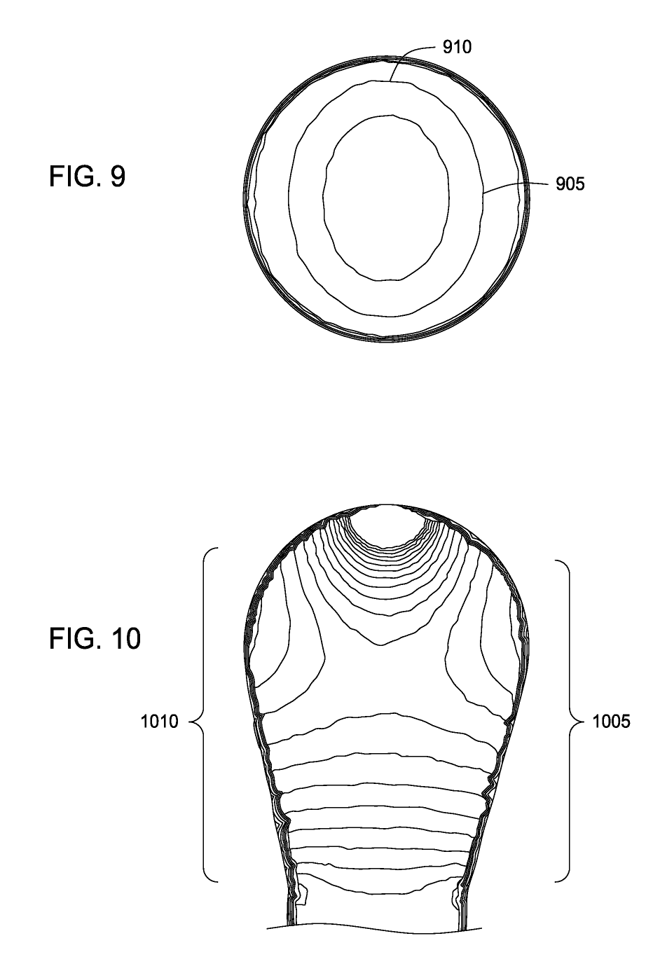

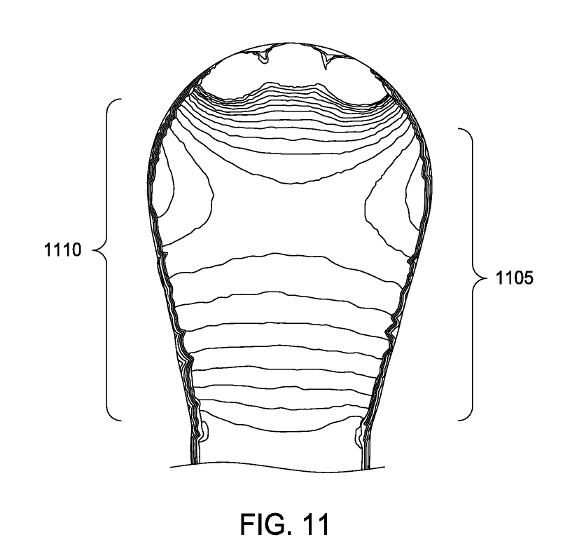

The bracket 1005, shown in FIG. 10, indicates the top of the 0.3 m/s velocity contour extends 9.2 m from the neck (bottom) of the transition section 130 at a position which is perpendicular to the plane of the aligned nozzles. The bracket 1105, shown in FIG. 11, indicates the top of the 0.3 m/s velocity contour extends 7.9 m from the neck (bottom) of the transition section 130 at a position which is planar to the aligned nozzles. The difference in the two distances 1005, 1105 is caused by the non-symmetrical velocity contours that result from the nozzles 110, 115, 120 being linearly disposed on the dome 135. The reduction in distance shown by bracket 1105 when compared to bracket 605 shown in FIG. 6 indicates improved wall sweeping in the dome 135 as the velocity profile increases faster than in the single outlet case. However, the benefit seen by the profile increase indicated by bracket number 1105 (in the plane parallel to the linearly aligned outlet nozzles) is more significant.

Referring to FIGS. 6, 8, 10 and 11 an arbitrary gas flow velocity at 1 m/s of the gas flow cone was used to compare the height of the gas flow cone above the neck (bottom) of the transition section 130. The height of the gas flow cone at a 1 m/s velocity contour extends 9.2 m (bracket 610) from the neck of the transition section 130 as the gas flow approaches a single outlet nozzle. The height of the gas flow cone at a 1 m/s velocity contour extends 9.6 m (bracket 810) from the neck of the transition section 130 as the gas flow approaches four outlet nozzles. The height of the gas flow cone at a 1 m/s velocity contour extends 9.9 m (bracket 1010) from the neck of the transition section 130 as the gas flow cone approaches the three outlet nozzle configuration when viewed perpendicular to the plane of the aligned outlet nozzles. The height of the gas flow cone at a 1 m/s velocity contour extends 9.4 m (bracket 1110) from the neck of the transition section 130 as the gas flow cone approaches the three outlet nozzles when viewed along the plane of the aligned nozzles.

The dimensions shown by brackets 610, 810, 1010, and 1110 in FIGS. 6, 8, 10, and 11, respectively, are an indication of the velocity increase as the gas is exiting the reactor. As the distance between the neck and the 1.0 m/s velocity contour increases, the probability of particle carryover decreases. It is therefore advantageous to maximize this distance in order to reduce particle carryover. The single outlet case (bracket 610) is used as a reference. The increase in distance in bracket 810 as compared to bracket 610 indicates lower potential for particle carryover. Brackets 1010 and 1110 also indicate lower potential for particle carryover when compared to bracket 610, with a more significant benefit seen in the direction perpendicular to the plane of the aligned nozzles (FIG. 10).

FIG. 12 shows the wall shear stress as a function of reactor height for the CFD simulations calculated at a 0.79 m/s reactor superficial gas velocity for the three reactor configurations discussed and described above with reference to FIGS. 5-11. In particular, FIG. 12 depicts the simulated wall shear stress of the vertical cross-sections shown in FIGS. 6, 8, 10, and 11. Wall shear stress is a measure of sweeping action and the greater the wall shear stress along the reactor wall correlates to a reduced probability of particulates (i.e., polymer and catalyst particles) being deposited onto the wall of the dome 135. Thus, higher wall shear stress correlates to a reduced probability that dome sheets will form within the reactor 100. The position of 0.0 m corresponds to the neck of the reactor 100.

As can be seen in FIG. 12, the wall shear stress in the transition section 130 for all three designs is relatively similar, which is expected. However, at about 8 m from the neck the wall shear stress of the three nozzle design and the four nozzle design increases more rapidly than the single nozzle design as the flow field approaches the reactor outlet nozzle(s). The highest wall shear stress 1205 is observed for the three nozzle configuration viewed along the plane of the three linearly disposed nozzles (FIG. 10). The second highest wall shear stress 1210 was observed for the four nozzle configuration (FIG. 8). The third highest wall shear stress 1215 was observed for the single nozzle configuration (FIG. 6). The lowest wall shear stress 1220 was observed for the three nozzle configuration viewed perpendicular to the plane of the three linearly disposed nozzles (FIG. 11). The lower wall shear stress 1220 observed along the reactor wall perpendicular to the plane of the three nozzles is a trade-off with the increased wall shear stress 1205 observed along the plane of the three nozzles. However, the three outlet design increases the total area of the dome 135 that is “swept” at a higher velocity than a reactor 105 having only a single outlet nozzle.

The increase in the wall shear stress provided by both the three nozzle and four nozzle designs as compared to the standard single nozzle configuration reduces the probability of particulates depositing on the wall of the reactor that can lead to the formation of dome sheets within the reactor. Both the three nozzle and four nozzle designs produce a greater wall shear stress that starts at a lower point along the reactor wall, which is expected to produce a reduction in particulates that deposit along the wall of the reactor as well as a reduction in the amount of particulate carryover through the nozzles and into the recycle line.

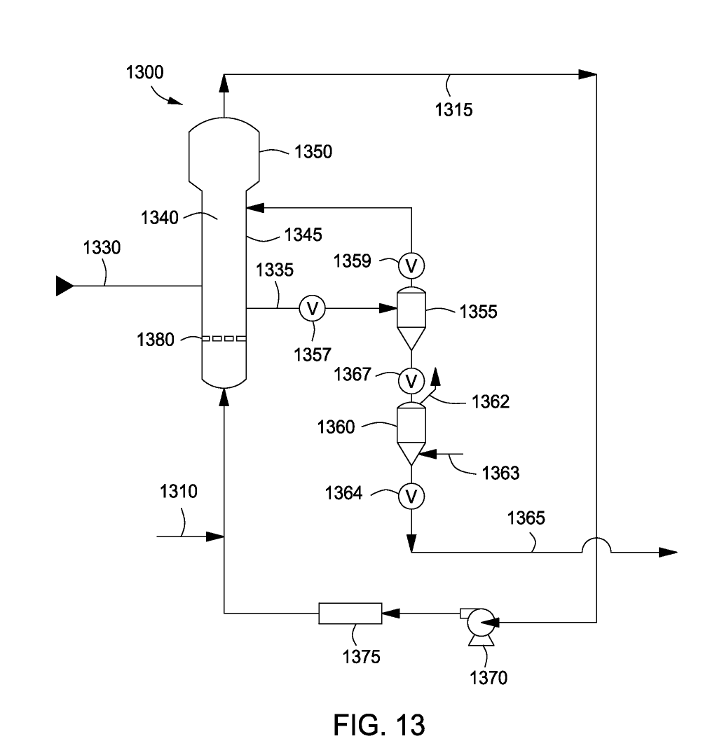

FIG. 13 depicts a flow diagram of an illustrative gas phase system 1300 for making polyolefin. In one or more embodiments, the system 1300 includes a reactor 1340 in fluid communication with one or more discharge tanks 1355 (only one shown), surge tanks 1360 (only one shown), recycle compressors 1370 (only one shown), and heat exchangers 1375 (only one shown). The polymerization system 1300 can also include more than one reactor 1340 arranged in series, parallel, or configured independent from the other reactors, each reactor having its own associated discharge tanks 1355, surge tanks 1360, recycle compressors 1370, and heat exchangers 1375 or alternatively, sharing any one or more of the associated discharge tanks 1355, surge tanks 1360, recycle compressors 1370, and heat exchangers 1375. For simplicity and ease of description, embodiments of the invention will be further described in the context of a single reactor train.

In one or more embodiments, the reactor 1340 can include a reaction zone 1345 in fluid communication with a velocity reduction zone or “top head” 1350. The reaction zone 1345 can include a bed of growing polymer particles, formed polymer particles and catalyst particles fluidized by the continuous flow of polymerizable and modifying gaseous components in the form of make-up feed and recycle fluid through the reaction zone 1345. In one or more embodiments, the reactor 1340 can be similar to the reactor 100 discussed and described above with reference to FIGS. 1-4. For example, the reactor 1340 can include two or more nozzles disposed on the top head 1350.

A feed or make-up stream via line 1310 can be introduced into the polymerization system at any point. For example, the feed or make-up stream via line 1310 can be introduced to the bed in the reaction zone 1345 or to the expanded section 1350 or to any point within the recycle stream 1315. Preferably, the feed stream or make-up stream 1310 is introduced to the recycle stream 1315 before or after the heat exchanger 1375. In FIG. 13, the feed or make-up stream via line 1310 is depicted entering the recycle stream in line 1315 after the cooler 1375.

The term “feed stream” as used herein refers to a raw material, either gas phase or liquid phase, used in a polymerization process to produce a polymer product. For example, a feed stream may be any olefin monomer including substituted and unsubstituted alkenes having two to 12 carbon atoms, such as ethylene, propylene, butene, pentene, 4-methyl-1-pentene, hexene, octene, decene, 1-dodecene, styrene, derivatives thereof, and combinations thereof. The feed stream can also include non-olefinic gas such as nitrogen and/or hydrogen. The feed stream may enter the reactor 1340 at multiple and different locations. For example, monomers can be introduced into the polymerization zone in various ways including direct injection through a nozzle (not shown) into the fluidized bed. The feed stream 1310 can further include one or more non-reactive alkanes that may be condensable in the polymerization process for removing the heat of reaction. Illustrative non-reactive alkanes include, but are not limited to, propane, butane, isobutane, pentane, isopentane, hexane, isomers thereof, derivatives thereof, and combinations thereof.

The fluidized bed has the general appearance of a dense mass of individually moving particles as created by the percolation of gas through the bed. The pressure drop through the bed is equal to or slightly greater than the weight of the bed divided by the cross-sectional area. It is thus dependent on the geometry of the reactor. To maintain a viable fluidized bed in the reaction zone 1345, the superficial gas velocity through the bed must exceed the minimum flow required for fluidization. Preferably, the superficial gas velocity is at least two times the minimum flow velocity. In one or more embodiments, the superficial gas velocity can range from about 0.3 m/s to about 2 m/s, about 0.35 m/s to about 1.7 m/s, or from about 0.4 m/s to about 1.5 m/s. Ordinarily, the superficial gas velocity does not exceed 1.5 m/s (5.0 ft/sec) and usually no more than 0.76 m/s (2.5 ft/sec) is sufficient.

In general, the height to diameter ratio of the reaction zone 1345 can vary in the range of from about 2:1 to about 5:1. The range, of course, can vary to larger or smaller ratios and depends upon the desired production capacity. The cross-sectional area of the top head 1350 is typically within the range of about 2 to about 3 multiplied by the cross-sectional area of the reaction zone 1345.

The velocity reduction zone or top head 1350 has a larger inner diameter than the reaction zone 1345. As the name suggests, the velocity reduction zone or top head 1350 slows the velocity of the gas due to the increased cross sectional area. This reduction in gas velocity allows particles entrained in the upward moving gas to fall back into the bed, allowing primarily only gas to exit overhead of the reactor 1340 through recycle gas stream 1315. In one or more embodiments, the recycle gas stream recovered via line 1315 can contain less than about 10% wt, less than about 8% wt, less than about 5% wt, less than about 4% wt, less than about 3% wt, less than about 2% wt, less than about 1% wt, less than about 0.5% wt, or less than about 0.2% wt of the particles entrained in reaction zone 1345.

The recycle stream via line 1315 can be compressed in the recycle compressor 1370 and then passed through the heat exchanger 1375 where heat is removed before it is returned to the bed. The heat exchanger 1375 can be of the horizontal or vertical type. If desired, several heat exchangers can be employed to lower the temperature of the recycle gas stream in stages. It is also possible to locate the recycle compressor 1370 downstream from the heat exchanger or at an intermediate point between several heat exchangers 1375. After cooling, the recycle stream 1315 is returned to the reactor 1340. The cooled recycle stream 1315 absorbs the heat of reaction generated by the polymerization reaction.

Preferably, the recycle stream 1315 is returned to the reactor 1340 and to the fluidized bed through a fluid distributor plate or fluid deflector 1380. The fluid deflector 1380 is preferably installed at the inlet to the reactor 1340 to prevent contained polymer particles from settling out and agglomerating into a solid mass and to prevent liquid accumulation at the bottom of the reactor 1340 as well to facilitate easy transitions between processes which contain liquid in the recycle stream 1315 and those which do not and vice versa. An illustrative deflector suitable for this purpose is described in U.S. Pat. Nos. 4,933,415 and 6,627,713.

A catalyst or catalyst system can be introduced to the fluidized bed within the reactor 1340 through one or more injection nozzles (not shown) in fluid communication with line 1330. The catalyst or catalyst system is preferably introduced as pre-formed particles in one or more liquid carriers (i.e. a catalyst slurry). Suitable liquid carriers can include mineral oil and liquid hydrocarbons including, but not limited to, propane, butane, isopentane, hexane, heptane octane, or mixtures thereof. A gas that is inert to the catalyst slurry such as, for example, nitrogen or argon can also be used to carry the catalyst slurry into the reactor 1340. In one or more embodiments, the catalyst or catalyst system can be a dry powder. In one or more embodiments, the catalyst or catalyst system can be dissolved in the liquid carrier and introduced to the reactor 1340 as a solution.

Under a given set of operating conditions, the fluidized bed is maintained at essentially a constant height by withdrawing a portion of the bed as product via line 1335 at the rate of formation of the particulate polymer product. Since the rate of heat generation is directly related to the rate of product formation, a measurement of the temperature rise of the fluid across the reactor (the difference between inlet fluid temperature and exit fluid temperature) is indicative of the rate of particulate polymer formation at a constant fluid velocity if no or negligible vaporizable liquid is present in the inlet fluid.

Fluid can be separated from a particulate product recovered via line 1335 from the reactor 1340. The separated fluid can be introduced to the recycle line 1315. In one or more embodiments, this separation can be accomplished when fluid and product leave the reactor 1340 and enter the product discharge tanks 1355 (one is shown) through valve 1357, which may be a ball valve designed to have minimum restriction to flow when opened. Positioned above and below the product discharge tank 1355 can be conventional valves 1359, 1367. The valve 1367 allows passage of product into the product surge tanks 1360 (only one is shown).

In at least one embodiment, to discharge particulate polymer from reactor 1340, valve 1357 can be opened while valves 1359, 1367 are in a closed position. Product and fluid enter the product discharge tank 1355. Valve 1357 is closed and the product is allowed to settle in the product discharge tank 1355. Valve 1359 is then opened permitting fluid to flow from the product discharge tank 1355 to the reactor 1340. Valve 1359 can then be closed and valve 1367 can be opened and any product in the product discharge tank 1355 can flow into the product surge tank 1360. Valve 1367 can then be closed. Product can then be discharged from the product surge tank 1360 through valve 1364. The product can be further purged via purge stream 1363 to remove residual hydrocarbons and conveyed via line 1365 to a pelletizing system or to storage (not shown). The particular timing sequence of the valves 1357, 1359, 1367, 1364 can be accomplished by use of conventional programmable controllers which are well known in the art.

Another preferred product discharge system which can be alternatively employed is that disclosed and claimed in U.S. Pat. No. 4,621,952. Such a system employs at least one (parallel) pair of tanks comprising a settling tank and a transfer tank arranged in series and having the separated gas phase returned from the top of the settling tank to a point in the reactor near the top of the fluidized bed.

The fluidized-bed reactor can be equipped with an adequate venting system (not shown) to allow venting the bed during start up and shut down. The reactor does not require the use of stirring and/or wall scraping. The recycle line 1315 and the elements therein (recycle compressor 1370, heat exchanger 1375) can be smooth surfaced and devoid of unnecessary obstructions so as not to impede the flow of recycle fluid or entrained particles.

Various techniques for preventing fouling of the reactor and polymer agglomeration can be used. Illustrative of these techniques are the introduction of finely divided particulate matter to prevent agglomeration, as described in U.S. Pat. Nos. 4,994,534 and 5,200,477 and the addition of negative charge generating chemicals to balance positive voltages or the addition of positive charge generating chemicals to neutralize negative voltage potentials as described in U.S. Pat. No. 4,803,251. Antistatic substances may also be added, either continuously or intermittently to prevent or neutralize electrostatic charge generation. Condensing mode operation, such as disclosed in U.S. Pat. Nos. 4,543,399 and 4,588,790 can also be used to assist in heat removal from the fluid bed polymerization reactor.

The conditions for polymerizations vary depending upon the monomers, catalysts, catalyst systems, and equipment availability. The specific conditions are known or readily derivable by those skilled in the art. For example, the temperatures can be within the range of from about −10° C. to about 120° C., often about 15° C. to about 110° C. Pressures can be within the range of from about 0.1 bar to about 100 bar, such as about 5 bar to about 50 bar, for example. Additional details of polymerization can be found in U.S. Pat. No. 6,627,713, which is incorporated by reference at least to the extent it discloses polymerization details.

Considering the polymer product via line 1365, the polymer can be or include any type of polymer or polymeric material. Illustrative polymers can include polyolefins, polyamides, polyesters, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, or mixtures of two or more of the above. Suitable polyolefins can include, but are not limited to, polymers comprising one or more linear, branched or cyclic C₂ to C₄₀ olefins, preferably polymers comprising propylene copolymerized with one or more C₃ to C₄₀ olefins, preferably a C₃ to C₂₀ alpha olefin, more preferably C₃ to C₁₀ alpha-olefins. More preferred polyolefins include, but are not limited to, polymers comprising ethylene including but not limited to ethylene copolymerized with a C₃ to C₄₀ olefin, preferably a C₃ to C₂₀ alpha olefin, more preferably propylene and or butene.

Preferred polymers include homopolymers or copolymers of C₂ to C₄₀ olefins, preferably C₂ to C₂₀ olefins, preferably a copolymer of an alpha-olefin and another olefin or alpha-olefin (ethylene is defined to be an alpha-olefin for purposes of this invention). Preferably, the polymers are or include homopolyethylene, homopolypropylene, propylene copolymerized with ethylene and or butene, ethylene copolymerized with one or more of propylene, butene or hexene, and optional dienes. Preferred examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics.

### Catalyst System

The catalyst system can include Ziegler-Natta catalysts, chromium-based catalysts, metallocene catalysts, and other single-site catalysts including Group 15-containing catalysts bimetallic catalysts, and mixed catalysts. The catalyst system can also include AlCl₃, cobalt, iron, palladium, chromium/chromium oxide or “Phillips” catalysts. Any catalyst can be used alone or in combination with the others. In one or more embodiments, a “mixed” catalyst is preferred.

The term “catalyst system” includes at least one “catalyst component” and at least one “activator,” alternately at least one co-catalyst. The catalyst system can also include other components, such as supports, and is not limited to the catalyst component and/or activator alone or in combination. The catalyst system can include any number of catalyst components in any combination as described, as well as any activator in any combination as described.

The term “catalyst component” includes any compound that, once appropriately activated, is capable of catalyzing the polymerization or oligomerization of olefins. Preferably, the catalyst component includes at least one Group 3 to Group 12 atom and optionally at least one leaving group bound thereto.

The term “leaving group” refers to one or more chemical moieties bound to the metal center of the catalyst component that can be abstracted from the catalyst component by an activator, thereby producing the species active towards olefin polymerization or oligomerization. Suitable activators are described in detail below.

As used herein, in reference to Periodic Table “Groups” of Elements, the “new” numbering scheme for the Periodic Table Groups are used as in the CRC Handbook of Chemistry and Physics (David R. Lide, ed., CRC Press 81^{st} ed. 2000).

The term “substituted” means that the group following that term possesses at least one moiety in place of one or more hydrogens in any position, the moieties selected from such groups as halogen radicals (for example, Cl, F, Br), hydroxyl groups, carbonyl groups, carboxyl groups, amine groups, phosphine groups, alkoxy groups, phenyl groups, naphthyl groups, C₁ to C₁₀ alkyl groups, C₂ to C₁₀ alkenyl groups, and combinations thereof. Examples of substituted alkyls and aryls includes, but are not limited to, acyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals, and combinations thereof.

### Chromium Catalysts

Suitable chromium catalysts can include di-substituted chromates, such as CrO₂(OR)₂; where R is triphenylsilane or a tertiary polyalicyclic alkyl. The chromium catalyst system may further include CrO₃, chromocene, silyl chromate, chromyl chloride (CrO₂Cl₂), chromium-2-ethyl-hexanoate, chromium acetylacetonate (Cr(AcAc)₃), and the like.

### Metallocenes

Metallocenes are generally described throughout in, for example, 1 & 2 Metallocene-Based Polyolefins (John Scheirs & W. Kaminsky, eds., John Wiley & Sons, Ltd. 2000); G. G. Hlatky in 181 Coordination Chem. Rev. 243-296 (1999) and in particular, for use in the synthesis of polyethylene in 1 Metallocene-Based Polyolefins 261-377 (2000). The metallocene catalyst compounds as described herein include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom. Hereinafter, these compounds will be referred to as “metallocenes” or “metallocene catalyst components”. The metallocene catalyst component is supported on a support material in an embodiment, and may be supported with or without another catalyst component.

The Cp ligands are one or more rings or ring system(s), at least a portion of which includes π-bonded systems, such as cycloalkadienyl ligands and heterocyclic analogues. The ring(s) or ring system(s) typically comprise atoms selected from the group consisting of Groups 13 to 16 atoms, or the atoms that make up the Cp ligands are selected from the group consisting of carbon, nitrogen, oxygen, silicon, sulfur, phosphorous, germanium, boron and aluminum and combinations thereof, wherein carbon makes up at least 50% of the ring members. Or the Cp ligand(s) are selected from the group consisting of substituted and unsubstituted cyclopentadienyl ligands and ligands isolobal to cyclopentadienyl, non-limiting examples of which include cyclopentadienyl, indenyl, fluorenyl and other structures. Further non-limiting examples of such ligands include cyclopentadienyl, cyclopentaphenanthreneyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7H-dibenzofluorenyl, indeno[1,2-9]anthrene, thiophenoindenyl, thiophenofluorenyl, hydrogenated versions thereof (e.g., 4,5,6,7-tetrahydroindenyl, or “H4Ind”), substituted versions thereof, and heterocyclic versions thereof.

### Group 15-Containing Catalyst

The “Group 15-containing catalyst” may include Group 3 to Group 12 metal complexes, wherein the metal is 2 to 8 coordinate, the coordinating moiety or moieties including at least two Group 15 atoms, and up to four Group 15 atoms. In one embodiment, the Group 15-containing catalyst component is a complex of a Group 4 metal and from one to four ligands such that the Group 4 metal is at least 2 coordinate, the coordinating moiety or moieties including at least two nitrogens. Representative Group 15-containing compounds are disclosed in, for example, WO 99/01460; EP A10 893 454; EP A10 894 005; U.S. Pat. No. 5,318,935; U.S. Pat. No. 5,889,128 U.S. Pat. No. 6,333,389 B2 and U.S. Pat. No. 6,271,325 B1. In one embodiment, the Group 15-containing catalyst includes a Group 4 imino-phenol complexes, Group 4 bis(amide) complexes, and Group 4 pyridyl-amide complexes that are active towards olefin polymerization to any extent.

### Activator

The term “activator” includes any compound or combination of compounds, supported or unsupported, which can activate a single-site catalyst compound (e.g., metallocenes, Group 15-containing catalysts), such as by creating a cationic species from the catalyst component. Typically, this involves the abstraction of at least one leaving group (X group in the formulas/structures above) from the metal center of the catalyst component. The catalyst components of embodiments described are thus activated towards olefin polymerization using such activators. Embodiments of such activators include Lewis acids such as cyclic or oligomeric poly(hydrocarbylaluminum oxides) and so called non-coordinating activators (“NCA”) (alternately, “ionizing activators” or “stoichiometric activators”), or any other compound that can convert a neutral metallocene catalyst component to a metallocene cation that is active with respect to olefin polymerization.

Lewis acids may be used to activate the metallocenes described. Illustrative Lewis acids include, but are not limited to, alumoxane (e.g., “MAO”), modified alumoxane (e.g., “TIBAO”), and alkylaluminum compounds. Ionizing activators (neutral or ionic) such as tri(n-butyl)ammonium tetrakis(pentafluorophenyl)boron may be also be used. Further, a trisperfluorophenyl boron metalloid precursor may be used. Any of those activators/precursors can be used alone or in combination with the others.

MAO and other aluminum-based activators are known in the art. Ionizing activators are known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) Chemical Reviews 1391-1434 (2000). The activators may be associated with or bound to a support, either in association with the catalyst component (e.g., metallocene) or separate from the catalyst component, such as described by Gregory G. Hlatky, Heterogeneous Single-Site Catalysts for Olefin Polymerization 100(4) Chemical Reviews 1347-1374 (2000).

### Ziegler-Natta Catalyst

Illustrative Ziegler-Natta catalyst compounds are disclosed in Ziegler Catalysts 363-386 (G. Fink, R. Mulhaupt and H. H. Brintzinger, eds., Springer-Verlag 1995); or in EP 103 120; EP 102 503; EP 0 231 102; EP 0 703 246; RE 33,683; U.S. Pat. No. 4,302,565; U.S. Pat. No. 5,518,973; U.S. Pat. No. 5,525,678; U.S. Pat. No. 5,288,933; U.S. Pat. No. 5,290,745; U.S. Pat. No. 5,093,415 and U.S. Pat. No. 6,562,905. Examples of such catalysts include those comprising Group 4, 5 or 6 transition metal oxides, alkoxides and halides, or oxides, alkoxides and halide compounds of titanium, zirconium or vanadium; optionally in combination with a magnesium compound, internal and/or external electron donors (alcohols, ethers, siloxanes, etc.), aluminum or boron alkyl and alkyl halides, and inorganic oxide supports.

Conventional-type transition metal catalysts are those traditional Ziegler-Natta catalysts that are well known in the art. Examples of conventional-type transition metal catalysts are discussed in U.S. Pat. Nos. 4,115,639, 4,077,904, 4,482,687, 4,564,605, 4,721,763, 4,879,359 and 4,960,741. The conventional-type transition metal catalyst compounds that may be used include transition metal compounds from Groups 3 to 17, or Groups 4 to 12, or Groups 4 to 6 of the Periodic Table of Elements.

These conventional-type transition metal catalysts may be represented by the formula: MRₓ, where M is a metal from Groups 3 to 17, or a metal from Groups 4 to 6, or a metal from Group 4, or titanium; R is a halogen or a hydrocarbyloxy group; and x is the valence of the metal M. Examples of R include alkoxy, phenoxy, bromide, chloride and fluoride. Examples of conventional-type transition metal catalysts where M is titanium include TiCl₄, TiBr₄, Ti(OC₂H₅)₃Cl, Ti(OC₂H₅)Cl₃, Ti(OC₄H₉)₃Cl, Ti(OC₃H₇)₂Cl₂, Ti(OC₂H₅)₂Br₂, TiCl_{3.1}/3AlCl₃ and Ti(OCl₂H₂₅)Cl₃.

Conventional-type transition metal catalyst compounds based on magnesium/titanium electron-donor complexes are described in, for example, U.S. Pat. Nos. 4,302,565 and 4,302,566. Catalysts derived from Mg/Ti/Cl/THF are also contemplated, which are well known to those of ordinary skill in the art. One example of the general method of preparation of such a catalyst includes the following: dissolve TiCl4 in THF, reduce the compound to TiCl3 using Mg, add MgCl2, and remove the solvent.

Conventional-type co-catalyst compounds for the above conventional-type transition metal catalyst compounds may be represented by the formula M₃M₄ᵥX_{2c}R_{3b-c}, wherein M₃ is a metal from Group 1 to 3 and 12 to 13 of the Periodic Table of Elements; M₄ is a metal of Group 1 of the Periodic Table of Elements; v is a number from 0 to 1; each X₂ is any halogen; c is a number from 0 to 3; each R₃ is a monovalent hydrocarbon radical or hydrogen; b is a number from 1 to 4; and wherein b minus c is at least 1. Other conventional-type organometallic cocatalyst compounds for the above conventional-type transition metal catalysts have the formula M₃R₃k, where M₃ is a Group IA, IIA, IIB or IIIA metal, such as lithium, sodium, beryllium, barium, boron, aluminum, zinc, cadmium, and gallium; k equals 1, 2 or 3 depending upon the valency of M₃ which valency in turn normally depends upon the particular Group to which M₃ belongs; and each R₃ may be any monovalent radical that include hydrocarbon radicals and hydrocarbon radicals containing a Group 13 to 16 element like fluoride, aluminum or oxygen or a combination thereof.

### Mixed Catalyst System

The mixed catalyst can be a bimetallic catalyst composition or a multi-catalyst composition. As used herein, the terms “bimetallic catalyst composition” and “bimetallic catalyst” include any composition, mixture, or system that includes two or more different catalyst components, each having a different metal group. The terms “multi-catalyst composition” and “multi-catalyst” include any composition, mixture, or system that includes two or more different catalyst components regardless of the metals. Therefore, the terms “bimetallic catalyst composition,” “bimetallic catalyst,” “multi-catalyst composition,” and “multi-catalyst” will be collectively referred to herein as a “mixed catalyst” unless specifically noted otherwise. In one preferred embodiment, the mixed catalyst includes at least one metallocene catalyst component and at least one non-metallocene component.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A fluidized bed reactor, comprising:
a cylindrical section;
a dome;
a transition section between the cylindrical section and the dome;
at least three outlet nozzles disposed on the dome; and
a recycle line in fluid communication with the at least three outlet nozzles.

2. The fluidized reactor of claim 1, wherein the first outlet nozzle is disposed on a central region of the dome, the second outlet nozzle is disposed on the dome at a first side of the first outlet nozzle and the third outlet nozzle is disposed on the dome at a second side of the first outlet nozzle.

3. The fluidized reactor of claim 2, wherein the first outlet nozzle, the second outlet nozzle, and the third outlet nozzle are linearly aligned along the dome.

4. The fluidized reactor of claim 2, wherein the first outlet nozzle, the second outlet nozzle, and the third outlet nozzle are linearly aligned along a centerline of the dome.

5. The fluidized rector of claim 1, wherein four outlet nozzles are disposed on the dome.

6. The fluidized reactor of claim 5, wherein the first outlet nozzle is disposed within a first quadrant of the dome, the second outlet nozzle is disposed within a second quadrant of the dome, the third outlet nozzle is disposed within a third quadrant of the dome, and the fourth outlet nozzle is disposed within a fourth quadrant of the dome.

7. The fluidized reactor of claim 1, wherein five outlet nozzles are disposed on the dome.

8. The fluidized reactor of claim 7, wherein the first outlet nozzle is centrally disposed on the dome, and wherein the second, third, fourth, and fifth outlet nozzles are radially disposed on the dome about the first nozzle.

9. The fluidized reactor of claim 1, wherein the dome is hemi-spherical.

10. The fluidized reactor of claim 1, wherein the transition section expands from the cylindrical section to the dome.

11. The fluidized reactor of claim 1, wherein the cylindrical section, the transition section, and the dome are centrally disposed about an axis.

12. A method for olefin polymerization; comprising:
forming a fluidized bed comprising a plurality of solid particles within a fluidized bed reactor comprising:
a cylindrical section;
a dome;
a transition section between the cylindrical section and the dome;
at least three outlet nozzles disposed on the dome, and
a recycle line in fluid communication with the at least three outlet nozzles; and
removing a recycle stream from the fluidized bed reactor through the at least three outlet nozzles.

13. The method of claim 12, wherein the plurality of solids comprises a polymer solid.

14. The method of claim 12, wherein the polymer solid comprises polyethylene or polypropylene polymer.

15. The method of claim 12, wherein a pressure in the fluidized bed reactor is about 5 bar to about 50 bar.

16. The method of claim 12, wherein the recycle stream comprises less than about 2% wt of the solid particles.

17. The method of claim 12, wherein the first outlet nozzle is disposed on a central region of the dome, the second outlet nozzle is disposed on the dome at a first side of the first outlet nozzle and the third outlet nozzle is disposed on the dome at a second side of the first outlet nozzle.

18. The method of claim 12, wherein four outlet nozzles are disposed on the dome.

19. The method of claim 12, wherein five outlet nozzles are disposed on the dome.

20. The method of claim 19, wherein the first outlet nozzle is centrally disposed on the dome, and wherein the second, third, fourth, and fifth outlet nozzles are radially disposed on the dome about the first nozzle.
